(19) United States
(12) Patent Application Publication
(10) Pub. No.: US 2021/0178411 A1
(43) Pub. Date: Jun. 17, 2021

(54) PAINT SPRAYER TIP CLEANING DEVICE

(71) Applicant: Edwin Perez, Davenport, FL (US)

(72) Inventor: Edwin Perez, Davenport, FL (US)

(21) Appl. No.: 16/716,136

(22) Filed: Dec. 16, 2019

(51) Int. Cl. B05B 1/28; B05B 11/00

(52) U.S. Cl. CPC B05B 1/28; B05B 11/3057; B05B 11/0037

(57) ABSTRACT

A paint sprayer tip cleaning device includes an elongated main body having an open top end, a closed bottom end and a middle section that define a watertight interior space. A pump body having a fluid pump and spray lever is removably secured along the top end of the main body. The pump body includes a plurality of male threads that engage complementary female threads located on a universal paint sprayer tip housing. A central opening is connected to the fluid pump. When connected to the pump body, the opening is in line with the sprayer tip opening. When the lever is engaged, fluid contained within the elongated main body is forced out of the pump opening thorough the tip opening.

### TECHNICAL FIELD

The present invention relates generally to cleaning devices, and more particularly to a paint sprayer tip cleaning device.

### BACKGROUND

The statements in this section merely provide background information related to the present disclosure and may not constitute prior art.

Airless paint sprayers are the first choice of professional painters and homeowners when large painting jobs need to be performed. These systems comprise a high-pressure pump having a hose that is connected to a paint source along one end and a spray handle along the other end. A removable tip housing is secured along the end of the handle and functions to receive a spray tip having a specifically shaped and sized opening through which the paint is discharged.

In this regard, it is not uncommon for professional painters to have multiple tips for use with the sprayer, depending on the type of materials being sprayed, and/or the particulars of the job (e.g., wide spray, narrow spray, thin spray, thick spray). In either instance, it is important to routinely clean these tips to avoid buildup within the body that reduces and ultimately blocks proper flow.

Unfortunately, owing to the small size of the tip openings, there is not an easy way to clean spray tips. Indeed, the most effective way to achieve proper cleaning is to run water or mineral spirits through the entire sprayer so as to force the same through the tip. Although effective, such a process is extremely time consuming and results in a period of time where the sprayer cannot be used. As such, this method is impractical for performance during a job when a painter noticed degraded performance of the tip.

Accordingly, it would be beneficial to provide a paint sprayer tip cleaning device that can receive the tip sprayer housing and that can force water or other cleaning agents through a paint tip so as to clean the same without suffering from the drawbacks described above.

### SUMMARY OF THE INVENTION

The present invention is directed to a paint sprayer tip cleaning device. One embodiment of the present invention can include an elongated main body having an open top end, a closed bottom end and a middle section that define a watertight interior space. A pump body having a fluid pump and spray lever can be removably secured along the top end of the main body.

In one embodiment, the pump body can include a plurality of male threads that engage complementary female threads located on a universal paint sprayer tip housing, and a central opening that is connected to the fluid pump. When connected to the pump body, the opening is in line with the sprayer tip opening. When the lever is engaged, fluid contained within the elongated main body is forced out of the pump opening through the tip opening.

In one embodiment, the bottom end of the main body is removable, and includes one or more clips for storing spare sprayer tips.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1A is a side view of the paint sprayer tip cleaning device that is useful for understanding the inventive concepts disclosed herein.

FIG. 1B is a perspective view of the paint sprayer tip cleaning device, in accordance with one embodiment of the invention.

FIG. 2 is a cutout view of the sprayer portion of the paint sprayer tip cleaning device, in accordance with one embodiment of the invention.

FIG. 3 is a perspective view of the paint sprayer tip cleaning device in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting, but rather to provide an understandable description of the invention.

### Definitions

As described herein, a “unit” means a series of identified physical components which are linked together and/or function together to perform a specified function.

As described herein, the term “removably secured,” and derivatives thereof shall be used to describe a situation wherein two or more objects are joined together in a non-permanent manner so as to allow the same objects to be repeatedly joined and separated.

As described throughout this document, the term “complementary shape,” and “complementary dimension,” shall be used to describe a shape and size of a component that is identical to or substantially identical to the shape and size of another identified component within a tolerance such as, for example, manufacturing tolerances, measurement tolerances or the like.

As described herein, the terms “connector” and “complementary connector” include any number of different elements that work together to repeatedly join two items together in a non-permanent manner. Several non-limiting examples include opposing strips of hook and loop material (i.e. Velcro®), attractively-oriented magnetic elements, threaded elements such as male and female twist connections, flexible strips of interlocking projections with a slider (i.e., zipper), tethers, buckles such as side release buckles, and compression fittings such as T-handle rubber draw latches, hooks, snaps and buttons, for example. Each illustrated connector and complementary connector can be permanently secured to the illustrated portion of the device via a permanent sealer such as glue, adhesive tape, or stitching, for example.

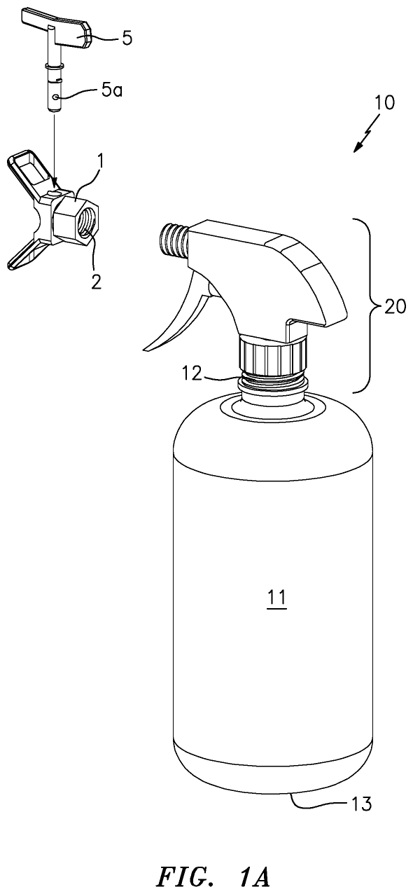

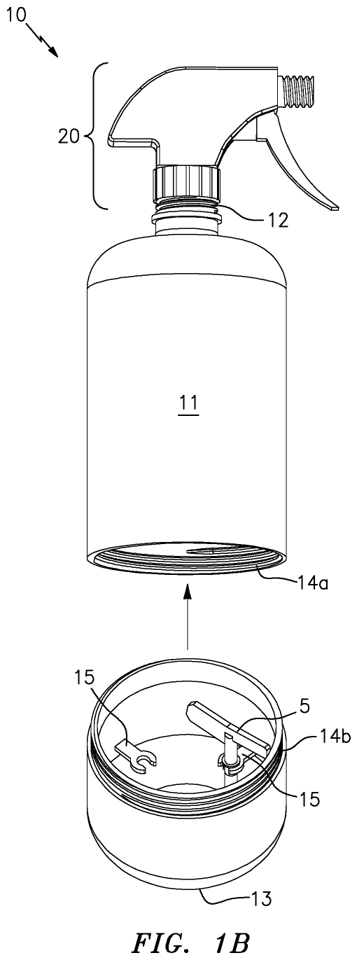

FIGS. 1A-3 illustrate one embodiment of a paint sprayer tip cleaning device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1A.

As shown in FIGS. 1A and 1B, the device 10 can include a main body 11 having a spray pump 20 secured thereon for engaging a universal paint tip housing 1 containing a conventional airless paint sprayer tip 5 having a centrally located opening 5a.

As described herein, the main body 11 can include any number of different shapes and sizes capable of receiving and storing liquids. In one embodiment, the main body can include an elongated hollow body section having a threaded open top end 12 and a closed bottom end 13.

In one embodiment, the bottom end 13 can be removably secured to the body section 11 via complementary threaded elements 14a and 14b. In such an embodiment, one or more clips 15, embedded magnets, or other such connectors can be positioned within the body 11 and/or bottom end 13 so as to receive and store one or more sprayer tips 5 that are not in active use. Such a feature advantageously allowing users to store spare tips within a cleaning solution so as to ensure they are clean when needed.

In either instance, the main body may be formed from materials that are, for example, relatively strong and stiff for their weight. Several non-limiting examples include but are not limited to injection molded plastic; stainless steel, or aluminum, for example. Moreover, although illustrated with regard to a particular shape or size, those of skill in the art will recognize that any number of other shapes and sizes are also contemplated.

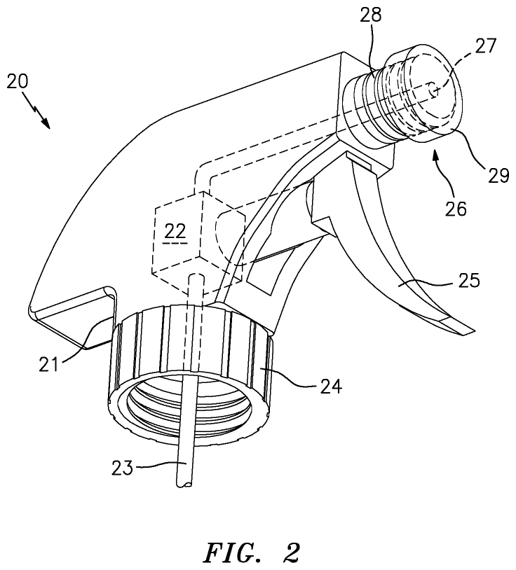

As shown at FIG. 2, the spray pump 20 can include a body section 21 having a fluid pump 22 therein. The lower portion of the pump body has an elongate draw tube 23 downwardly extending therefrom, and a threaded fastening ring 24 rotatably mounted thereto and disposed around the draw tube. The draw tube is inserted through the upper end of the main body and the fastening ring is threaded onto the upper end 12 of the main body 11. The draw tube is in fluid communication with the fluid pump in the pump body and has an open lower end for permitting fluid in the main body to be drawn up upon pumping action by the fluid pump.

A spray lever 25 is pivotally coupled to the fluid pump 22 and biases in a direction away from the lower portion of the pump body by a spring or other biasing means commonly used in spray bottle pumps. The pump lever is operatively connected to the fluid pump such that pivoting of the pump lever towards the lower portion of the pump body in turn operates the fluid pump to draw fluid from the main body up into the draw tube and up into the pump body.

As shown, a spray head 26 is positioned along the front end of the body section. The spray head is in fluid communication with the pump 22 and includes an opening 27 through which fluid passing from the main body 11 through the pump 22 is discharged. The spray head also including a plurality of threaded elements 28 that are positioned along the exterior surface (e.g., male threads) having a shape and size that are complementary to the female threaded elements 2 of a universal paint tip housing 1.

In the preferred embodiment, a resilient sealing mechanism 29, such as a rubber gasket, for example can be positioned along the distal end of the spray head so as to surround the opening 27.

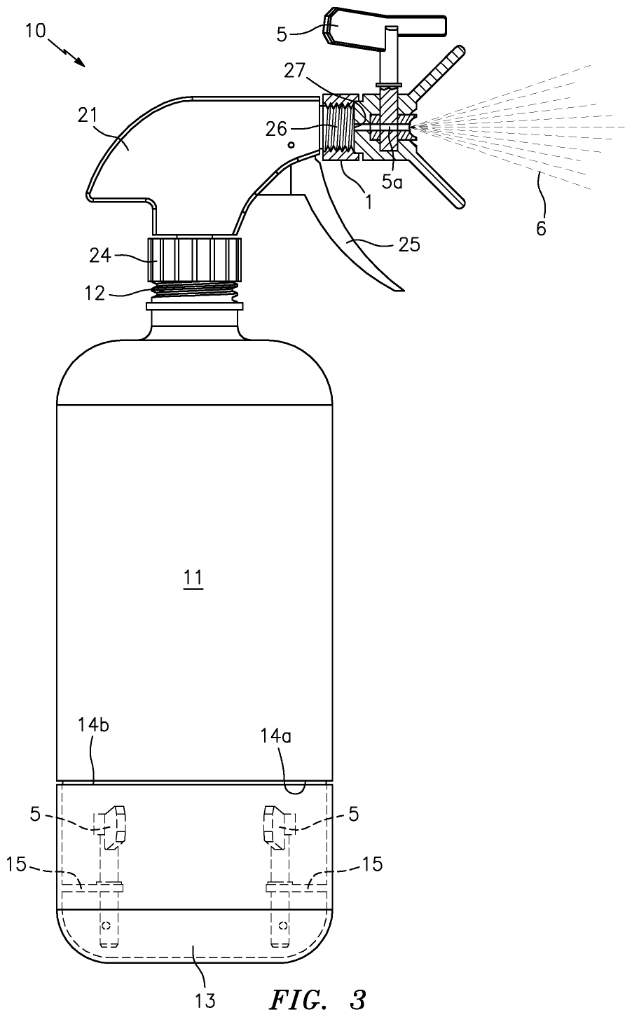

FIG. 3 illustrates one embodiment of the device 10 in operation. As shown, the housing 1 can be secured onto the spray head 26 via the above described fasteners. When so positioned, the opening 5a of the sprayer tip 5 will be positioned in line with the opening 27 of the device. Moreover, the gasket 29 can function to engage the side of the sprayer tip so as to create a watertight seal to force all fluid 6 exiting the opening 27 through the sprayer tip opening 5a without a loss of pressure.

Accordingly, the above described device can function to simultaneously store and clean any number of paint sprayer tips utilizing pressurized water or other liquids without the hassle and effort associated with previous known storage and cleaning methods.

As described herein, one or more elements of the tip cleaning device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

In this regard, one embodiment of the device can include a sprayer tip housing that is permanently secured onto the end of the pump 20. The housing functioning to engage and receive known sprayer tips 5 via a side locking mechanism, while not requiring a user to remove the housing from their spraying equipment.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A sprayer tip cleaning device, comprising:
an elongated main body having an open top end, a closed bottom end and a middle section that define a watertight interior space;
a pump body that is removably positioned along the open top end of the main body;
a fluid pump that is positioned within the pump body;
a spray lever that is in communication with the fluid pump; and
a spray head that is positioned along one end of the pump body, said spray head including functionality for engaging a universal paint tip housing containing a paint sprayer tip,
wherein the spray head is in fluid communication with the fluid pump and is configured to discharge a fluid through the paint sprayer tip.

2. The device of claim 1, further comprising:
a plurality of threaded elements that are disposed along an outside surface of the spray head.

3. The device of claim 2, wherein the plurality of threaded elements include a complementary shape and a complementary size to another plurality of threaded elements disposed on the universal paint tip housing.

4. The device of claim 1, wherein the spray head includes a single aperture along a distal end.

5. The device of claim 1, wherein the single aperture is aligned with an aperture located in the paint sprayer tip when the spray head is engaged to the universal paint tip housing.

6. The device of claim 1, wherein the closed bottom end of the main body is removably secured to the middle section.

7. The device of claim 6, further comprising:
at least one connector that is disposed along an inside portion of the closed bottom end.

8. The device of claim 7, wherein the at least one connector includes functionality for engaging a spare paint sprayer tip.
